(19) United States
(12) Patent Application Publication
(10) Pub. No.: US 2024/0311490 A1
(43) Pub. Date: Sep. 19, 2024

(54) CODE REPAIR USING ERROR-CHECKING MACROS AS SIGNALS OF VULNERABILITIES

(71) Applicant: MICROSOFT TECHNOLOGY LICENSING, LLC., Redmond, WA (US)

(72) Inventors: AARON YUE-CHIU CHAN, PROVO, UT (US); KALPATHY SITARAMAN SIVARAMAN, BOTHELL, WA (US); NEELAKANTAN SUNDARESAN, BELLEVUE, WA (US); ROSHANAK ZILOUCHIAN MOGHADDAM, KIRKLAND, WA (US)

(21) Appl. No.: 18/120,983

(22) Filed: Mar. 13, 2023

(51) Int. Cl. G06F 21/57

(52) U.S. Cl. CPC G06F 21/577; G06F 2221/033

(57) ABSTRACT

A source code repair system detects a potential software vulnerability of a source code program of a codebase by utilizing error-checking macros as signals of the potential software vulnerability. A machine learning classifier identifies expressions used as an argument in an error-checking macro in a software program to be a potential software vulnerability. Upon the classifier model classifying an expression as a potential software vulnerability, the system searches for other uses of the expression in the codebase. The prevalence of an expression in the codebase and the frequency of the methods containing the expression are used to filter out false positives.

### BACKGROUND

A source code bug is an error in a source code program that causes the program to behave in an unintended manner, such as producing erroneous results. There are various types of source code bugs. A functional bug is one where the program fails to perform in accordance with a functional description or specification. A compiler error is a type of software bug that fails to conform to the syntax of a programming language of the program. A runtime error occurs during runtime such as logic errors, I/O errors, undefined object errors, division by zero errors, etc.

A software vulnerability differs from source code bugs, such as functional bugs, compiler errors and runtime errors since they do not produce an erroneous result. By contrast, a software vulnerability is a programming defect that causes significant performance degradation, such as excessive resource usage, increased latency, reduced throughput, and overall degraded performance or is exploited for malicious intent. Software vulnerabilities are difficult to detect due to the absence of fail-stop symptoms. With the increased complexity of software systems, there is an emphasis on the efficient use of resources and system security and hence, improvements in detecting and remedying software vulnerabilities.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

A source code repair system detects a potential software vulnerability of a source code program of a codebase by utilizing error-checking macros as signals of the potential software vulnerability. A machine learning classifier identifies expressions used as an argument in an error-checking macro in a software program to be a potential software vulnerability. Upon the classifier model classifying an expression as a potential software vulnerability, the system searches for other uses of the expression in the codebase. The prevalence of an expression in the codebase and the frequency of the methods containing the expression are used to filter out false positives.

A list of repair code candidates showing the use of the expression within an error-checking macro from other locations in the codebase is generated. The repair code candidates are ranked based on how close the directory and file name of each repair code candidate matches the directory and file name of the source code file having the software vulnerability. The list of repair code candidates is output to a developer within an integrated development environment (IDE), source code editor, or source code repository.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF DRAWINGS

FIG. 1 is a schematic diagram illustrating an exemplary source code repair system.

FIGS. 2A-2B are schematic diagrams illustrating exemplary applications of the source code repair system.

FIG. 3 is a schematic diagram illustrating an exemplary neural classifier model in the training and fine-tuning configurations of a neural encoder transformer with attention.

FIG. 4 is a flow diagram illustrating an exemplary method of the source code repair system.

FIG. 5 is a flow diagram illustrating an exemplary method for generating a semi-supervised training dataset for the neural classifier model from macro definition files of a codebase.

FIG. 6 is a flow diagram illustrating an exemplary method of filtering the software vulnerabilities classified by the model.

FIG. 7 is a block diagram illustrating an exemplary operating environment.

### DETAILED DESCRIPTION

### Overview

The present disclosure relates to the detection of a software vulnerability in a source code program of a codebase from signals in the programs that are associated with bug-prevention techniques, such as error-checking macros. These signals are used to train a deep learning model to learn the source code context surrounding these signals in order to identify similar patterns in other parts of the source code where the signals are not present.

A codebase is a collection of source code programs that make up a software application or service. A codebase may include a project of an Integrated Development Environment (IDE). The source code programs of the codebase may include libraries, configuration files, macro definition files, readme files, example scripts, etc.

An error-checking macro is a single instruction that expands into a set of instructions to perform a check on an expression. The error-checking macro is used to prevent a software vulnerability in the program. For example, the error-checking macro may be used to check that an index into an array does not exceed the bounds of the array, check that an expression does not generate a null value, or check that an expression does not produce an error value, etc. The expression used in the error-checking macro is considered a potential software vulnerability when seen in a context outside of an error-checking macro.

A machine learning classifier model is trained to detect software vulnerabilities from a supervised training dataset that includes positive samples and negative samples. A positive sample is an expression used as an argument in an error-checking macro and a negative sample is an expression that is not used in an error-checking macro.

In one aspect, the classifier model is a neural encoder transformer model pre-trained on an unsupervised dataset of source code samples and fine-tuned on a supervised dataset of labeled samples of source code containing the positive and negative samples. From this training, the neural encoder transformer model learns to identify the likelihood that the expression is likely to be a potential software vulnerability when seen outside of the context of an error-checking signal.

In the case where the neural encoder transformer identifies an expression as a potential software vulnerability, a semantic matching filter and a method usage index are used to eliminate expressions that are likely to be a false positive. The semantic matching filter searches for the expressions in other contexts throughout the codebase. If the expression is not found in a threshold number of occurrences in the files of the codebase, then the expression is eliminated as a false positive. The method usage index indicates the frequency of the usage of the method within in the codebase. If the method usage index exceeds a threshold, then the expression is eliminated as a potential software vulnerability.

The occurrences of the expression in contexts outside of an error-checking macro are used as candidates to repair the software vulnerability. These candidates are ranked based on how close the directory and file name associated with the source code file having the identified software vulnerability matches the directory and file name of each of the repair code candidates. The top-k closest matching repair code candidates are output, where k is a configurable parameter.

The detection of the software vulnerabilities in this manner differs from static code analysis tools, such as a compiler, syntax checker, code quality analyzer, security analyzer, formal verification analyzer, and performance analyzer. Static code analysis tools analyze software programs without executing them. These tools need to be tuned and updated when new vulnerabilities are discovered. The techniques described herein do not require the software to be compiled or built making these techniques scalable to codebases of any size.

Even though traditional tools can analyze code statically, without executing them, they require the codebase to be compiled and built in order to bring for the source code artifacts to a representation upon which these analyzers can work. There is a known significant cost to building codebases, which increases with the codebase size. Large codebases can take hours or days to build which causes challenge and friction to enable a static analyzer. The runtime of the analyzer is affected by the size of the codebase.

In contrast, the disclosed technique works on raw code and textual code as is without needing to be compiled. The disclosed technique does not require build artifacts. It scales very easily with the size of the codebase. The system can work in an IDE to give immediate feedback to the developer while writing code, run on checked-in code in a version-controlled source code repository, and can be enabled seamlessly, as per technical constraints, requirements or convenience.

Attention now turns to a more detailed description of the system, method, and components used in the vulnerability detection and repair system.

### System

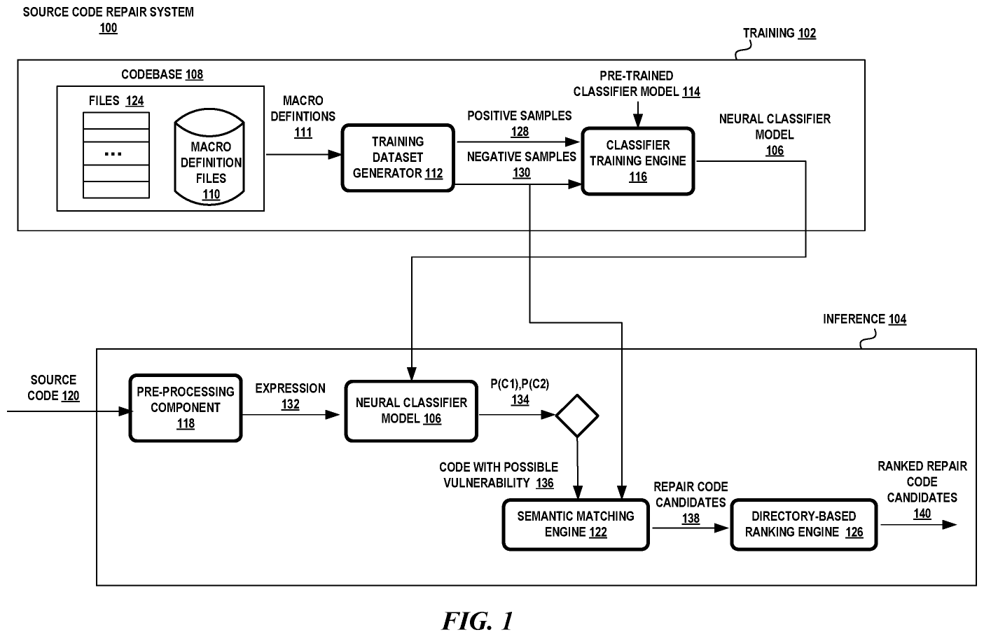

FIG. 1 illustrates an exemplary source code repair system 100. The source code repair system 100 includes a training phase 102 and an inference phase 104. In the training phase 102, a neural classifier model 106 is trained from error-checking signals mined from a codebase 108. In the inference phase 104, the neural classifier model 106 is used to identify potential software vulnerabilities from programs in the codebase.

In the training phase 102, the system 100 utilizes the macro definition files 110 of a codebase 108, a training dataset generator 112, a pre-trained classifier 114, and a classifier training engine 116. In the inference phase 104, the system uses a pre-processing component 118 to analyze expressions of a source code program 120 of the codebase 108 for potential vulnerabilities, the neural classifier model 106, a semantic matching engine 122 and a directory-based ranking engine 126.

A codebase 108 is a collection of files 124 that make up a software application or service. The files 124 of the codebase may include source code files, libraries, configuration files, macro definition files 110, readme files, example scripts, etc. A macro definition file contains the definitions of the macros 114 used in a source code program of the code base. In some aspects, a macro definition may be present in the header files of a source code file of a codebase or stored in one or more separate macro definition files.

For example, below is a macro definition for the RETURN_IF_ERROR macro written in the C#programming language:

```
#define RETURN_IF_ERROR(expr, status)
if (! (expr ) )
{
  LOG_ERROR(expr);
  return(status);
}
```

The macro, RETURN_IF_ERROR, is defined by the source code shown above. In this example, the macro RETURN_IF_ERROR takes two arguments or parameters: expr, which is an expression, and status, which is an error code. The macro RETURN_IF_ERROR logs an error upon failure when the condition of the expression is not met and return the error status. Otherwise, when the condition is met, the program continues executing.

The training set generator 112 extracts the macro definitions from the codebase 108 to generate a fine-tuning dataset of positive samples 128 and negative samples 130 to train the neural classifier model 106. The positive samples 128 and the negative samples 130 are then used by the classifier training engine 116 to fine-tune a pre-trained classifier model 114 to learn to recognize code patterns indicative of a context of a software vulnerability.

The pre-trained classifier model 114 is trained on source code snippets written in the programming language of the source code files of the codebase. The pre-trained classifier 114 learns to understand the relationships between the different elements of a programming language and an understanding of source code. Source code differs from a natural language (e.g., English) since programmers use, at times, arbitrary, complex and long names to represent a variable, function or other code elements. Source code can be learned from a large unsupervised abundant corpus of code snippets from different programming languages and/or from natural language code summaries from which the model learns statistical properties of the source code, such as syntactic rules of the programming languages, as well as semantic information from co-occurrence of specific variable and method names.

In an aspect, the neural classifier model 106 is a deep learning classifier. A deep learning machine learning model differs from traditional machine learning models that do not use neural networks. Machine learning pertains to the use and development of computer systems that are able to learn and adapt without following explicit instructions, by using algorithms and statistical models to analyze and draw inferences from patterns in data. Machine learning uses different types of statistical methods to learn from data and to predict future decisions. Traditional machine learning includes statistical techniques, data mining, Bayesian networks, Markov models, clustering, support vector machine, and visual data mapping.

Deep learning differs from traditional machine learning since it uses multiple stages of data processing through many hidden layers of a neural network to learn and interpret the features and the relationships between the features. Deep learning embodies neural networks which differs from the traditional machine learning techniques that do not use neural networks. There are various types of deep learning models that generate source code, such as recurrent neural network (RNN) models, convolutional neural network (CNN) models, long short-term memory (LSTM) models, and neural transformers. In an aspect, the neural classifier model 106 is a neural encoder transformer with attention.

In the inference stage 104, the neural classifier model 106 is used to identify potential software vulnerabilities. A pre-processing component 118 receives a source code program 120 and extracts various expressions from the program. An expression 132 is a combination of constants, variables, methods, functions and/or operators of a programming language that produce a value or result. An expression may be a method invocation, an API, a statement, a declaration, an assignment statement and so on.

The neural classifier model infers whether or not an expression from the source code program is a potential software vulnerability. The neural classifier model generates a probability for a class, C1, which represents the likelihood that the expression is a potential software vulnerability and a probability for a class, C2, which represents the likelihood that the expression is not a potential software vulnerability 134.

The semantic matching engine 122 finds other occurrences of the expression in the files of the codebase. The semantic matching engine 122 generates a method usage index for each method that is used in an error-checking macro. If the set of usages of the expression within an error-checking macro exceeds a threshold and the method usage index exceeds a threshold, the expression is considered a software vulnerability. Otherwise, the expression is a false positive.

The repair code candidates 138 include the expression within an error-checking macro. The repair code candidates are ranked 140 by the directory-based ranking engine 126 in an order based on the directory and file name of each repair code candidate closely matching the directory and file name of the source code file containing the expression.

Attention now turns to a more detailed discussion of the application of the repair code system.

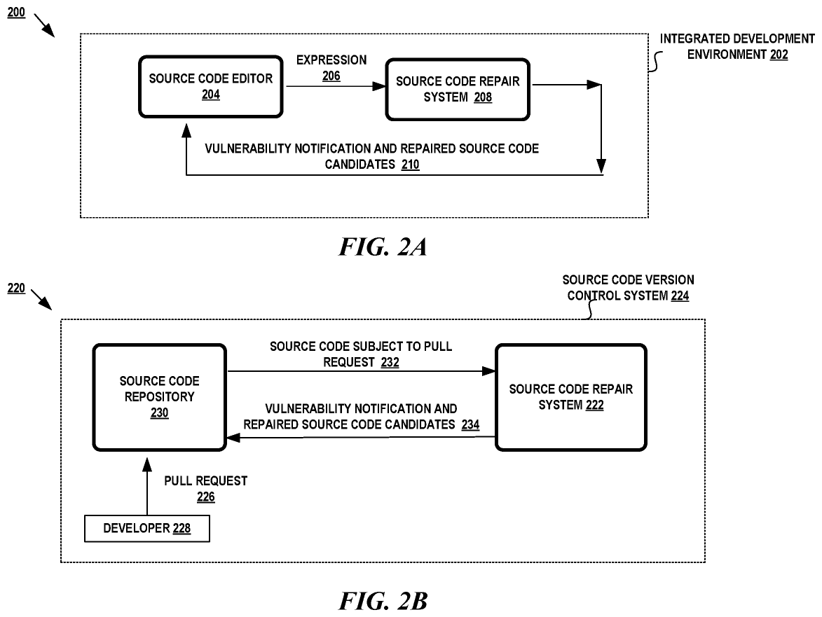

FIGS. 2A and 2B illustrate exemplary systems utilizing the source code repair system. Turning to FIG. 2A, there is shown a system 200 where the source code repair system operates within an IDE 202. The IDE 202 is a software development tool that provides tools for software development, such as without limitation, source code editors, compilers, debuggers, build automation tools, and the like. The IDE 202 may incorporate a source code editor 204 that interacts with a developer to generate or edit source code. The source code repair system 208 may operate as a background process that monitors the source code input into the source code editor 204. At various times during the development, the source code repair system may receive expressions 206 extracted from the source code editor. The expressions are analyzed using the neural classifier model as explained above to identify a software vulnerability in the source code under development. Upon detection of such a software vulnerability, the source code repair system notifies the source code editor that the expression may be a software vulnerability and provides a list of repair code candidates showing the use of the expression with an error-checking macro 210.

FIG. 2B illustrates a system 220 where the source code repair system 222 operates with a source code version control system 224 to identify vulnerabilities in the source code of a pull request 226 submitted by a developer 228. The source code version control system 224 detects a pull request 226 and initiates a request 232 for the source code repair system 222 to analyze the source code subject to the pull request 226 for a software vulnerability. The system 222 notifies the source code repository of its findings and returns the list of repair code candidates to the developer 234.

Attention now turns to a more detailed description of the classifier model. In one embodiment, the classifier model is constructed as a neural encoder transformer with attention. The neural encoder transformer with attention is better suited for classification tasks due to the type of attention used in the encoder. The encoder uses bi-directional attention which enables the encoder to learn the relationships of the tokens/subtokens in an input sequence both before and after their occurrence. Classifiers are trained to interpret a model's internal representation into a class label. Since bi-directional attention allows the model's internal representation to depend on all other subtokens, and not just the previous subtokens, bi-directional attention leads to superior classification performance.

### Neural Encoder Transformer Model

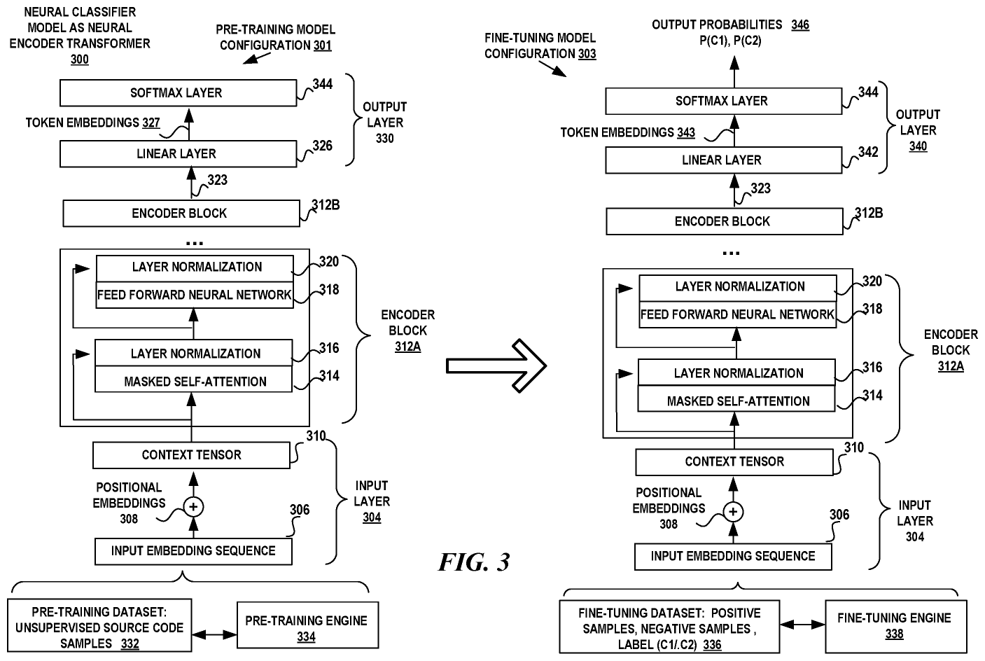

FIG. 3 illustrates an exemplary neural encoder transformer model 300. In pre-training 301, the neural encoder transformer model learns to understand source code, the relationship between the different code elements, and the syntax of a programming language. The weights of the model (e.g., token/subtoken embeddings, attention weights (K,V,Q)) are initialized randomly and changed during pre-training based on the samples in the pre-training dataset 332. The weights of the model are optimized based on reducing a cost function. A pre-training engine 334 uses a pre-training dataset of unsupervised source code samples 332 to pre-train the model for the optimal weights. During fine-tuning 303, the weights computed from the pre-training are used as the initial weights and tuned for the fine-tuning task. A fine-tuning engine 338 uses a fine-tuning dataset 336 composed of positive samples having a software vulnerability and negative samples that do not contain a software vulnerability and a label that identifies whether or not the sample represents a vulnerability.

The neural encoder transformer 301 includes an input layer 304, one or more encoder blocks 312, and an output layer 330. The input layer 304 includes input embeddings of an input sequence of the pre-training dataset 306 and positional embeddings 308 that represents an order of the tokens/subtokens in an input embedding sequence. The input embedding sequence 306 and the positional embeddings 308 are combined to form a context tensor 310.

An encoder block (312A-312B) consists of two layers. The first layer includes a masked self-attention component 314 followed by a layer normalization component 316. The second layer includes a feed-forward neural network 318 followed by a layer normalization component 320. The context tensor 310 is input into the masked self-attention layer 314 of the encoder block with a residual connection to layer normalization 316. The output of the layer normalization 316 is input to the feed-forward neural network 318 with another residual connection to layer normalization 320. The output of each encoder block (312A-312B) is a set of hidden representations 323. The set of hidden representations 323 is then sent through additional encoder blocks, if multiple encoder blocks exist.

Attention is used to decide which parts of the input sequence are important for each token/subtoken, especially when decoding long sequences since the encoder is limited to encoding a fixed-size vector. Attention mechanisms gather information about the relevant context of a given token/subtoken and then encode that context into a vector which represents the token/subtoken. It is used to identity the relationships between subtokens in the long sequence while ignoring other subtokens that do not have much bearing on a given prediction.

The masked self-attention component 314 takes a context tensor 310 and weighs the relevance of each token/subtoken represented in the context tensor to each other by generating attention weights for each token/subtoken in the input embedding sequence 306. In one aspect, the attention function is scaled dot-product attention which is described mathematically as follows:

$$Attention ( Q , K , V ) = softmax ( \frac{{QK}^{T}}{\sqrt{{d}_{k}}} ) V ,$$

where the input consists of queries Q and keys K of dimension dₖ, and values V of dimension dr. Q is a matrix that contains the query or vector representation of one token/subtoken in a sequence, K is the vector representations of all tokens/subtokens in the sequence, and V is the vector representations of all the tokens/subtokens in the sequence.

The queries, keys and values are linearly projected h times in parallel with dr output values which are concatenated to a final value:

MultiHead(Q, K, V)=Concat(head₁, . . . ,headₙ)W°,

where headᵢ=Attention(QWᵢ^{Q}, KWᵢ^{K}, VWᵢ^{V}),

with parameter matrices Wᵢ^{Q}ϵ [symbol] ^{d}^{_{model}}^{×d}^{ₖ}, Wᵢ^{K} ϵ [symbol] ^{d}^{_{model}}^{×d}^{ₖ}, Wᵢ^{V}ϵ [symbol] ^{d}^{_{model}}^{×d}^{ₖ}, and W^{O}ϵ [symbol] ^{hd}^{ᵥ}^{×d}^{_{model}}.

In order to reduce the training time of the neural encoder transformer, layer normalization is used between the layers. The layer normalization component normalizes the inputs across the features. The mean and standard deviation is computed across the feature dimensions. There is a first layer normalization 316 that precedes the feed-forward neural network 318 and a second layer normalization 320 that follows the feed-forward neural network 318. The feed-forward neural network 318 processes each output encoding separately. The output of the top encoder block is a set of attention vectors K and V 323 that represent the last hidden layer.

Pre-training is the process where the model's parameters (e.g., embeddings, weights, biases) are learned from unsupervised data. The model learns the parameters through the optimization of the cost function used by the neural network layer of the model. The cost function determines the error loss from the previous epoch which is then backpropagated to the preceding layers of the model. The model's parameters are updated through backpropagation based on the error loss determined by the cost function.

The optimization of the cost function used in the neural network layer of the model determines the error loss from the previous epoch which is then backpropagated to the preceding layers of the model. The model's parameters are updated through backpropagation based on the error loss determined by the cost function. Once the model is fully trained, the model's embeddings are stored in a separate data structure and used in the inference process to transform an input sequence of tokens into a sequence of input embeddings. Each token in an input sequence is converted into its corresponding embedding resulting in the sequence of input embeddings that is applied to the model.

Fine-tuning is the process where the model's parameters are learned or updated from supervised data. Pre-training and fine-tuning are both training processes. A model may be trained through pre-training, fine-tuning, or any combination thereof. The model may have had a previous training phase that consisted of pre-training the model with unsupervised data, fine-tuning the model with supervised data, or any combination thereof.

Each of the fine-tuning samples of a fine-training dataset is an input sequence that is transformed into a sequence of input embeddings. The input sequence is tokenized and each token in replaced with a respective embedding transforming the input sequence into a sequence of input embeddings. An embedding is a learned representation for the text-based tokens where tokens that have a common meaning have a common representation. An embedding is a mapping of discrete categorical variables to a vector of continuous numbers. There is an embedding for each token of the source code used in the fine-tuning dataset. Each token embedding has a corresponding positional embedding. The neural transformer model does not read each token sequentially and as such, has no knowledge of the token's position in a sequence without additional position information. The positional embedding is used to encode position information about a token's position in a sequence into the neural transformer model.

In the pre-training model configuration 301, the output layer includes a linear layer 326 from which the subtoken/token embeddings 323 are output and a softmax layer 328. For fine-tuning, the neural encoder transformer model contains the same structure as the pre-trained model configuration except for the addition of a different output layer 340. The output layer of the pre-trained model is replaced with a classification layer that learns a new weight matrix of dimension K×H from randomly-initialized values, where K is the number of classes in a downstream classification task and where H is the dimension of the output of last encoder block.

The output layer of the pre-trained model 330 is not used since its weight matrix is of a different size that may not contain the classes of the target classification task. Instead, the new output layer 340 is used which has the number of hidden units set to the number of classes K of the fine-tuning classification task with a softmax activation function 344. The predicted probability P for the j-th class given an output of last encoder block x and weight matrix W corresponding to the classification layer is as follows:

P (y=j|x)=exp (x^{T}Wⱼ+b)/[Σₖ₌₁ . . . . K exp (x^{T} Wₓ+b)], where K is the number of classes, W is the weight matrix of dimension K×H, H is the dimension of x, the output of last encoder block, and b is the bias value.

The output layer 340 consists of a linear layer 342 and a softmax layer 344. The linear layer 342 is a fully-connected neural network that projects the raw scores output by the last layer of the neural network into a logits vector. The softmax layer 344 applies the softmax function to the logits vector to compute a vector that represents the probability distribution 346 of two classes, P(C1), P(C2), where C1 is the class indicative of a software vulnerability and C2 is the class indicative of no software vulnerability.

### Methods

Attention now turns to description of the various exemplary methods that utilize the system and device disclosed herein. Operations for the aspects may be further described with reference to various exemplary methods. It may be appreciated that the representative methods do not necessarily have to be executed in the order presented, or in any particular order, unless otherwise indicated. Moreover, various activities described with respect to the methods can be executed in serial or parallel fashion, or any combination of serial and parallel operations. In one or more aspects, the method illustrates operations for the systems and devices disclosed herein.

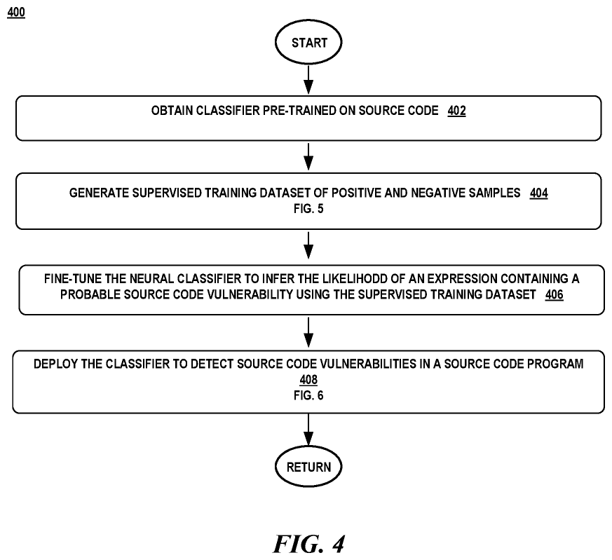

FIG. 4 illustrates an exemplary method of the source code repair system 400. The system obtains a pre-trained neural classifier model having been trained on source code to learn the statistical properties of the source code, such as syntactic rules of the programming languages, as well as semantic information from co-occurrence of specific variable and method names (block 402).

The pre-training engine uses a pre-training dataset from a diverse corpus of unlabeled source code programs or files. In some aspects, the pre-training dataset may also include natural language text that pertains to a source code file such as source code summaries which describe the operation of a source code construct. This is referred to as unsupervised learning since the model draws inferences from the input data without labeled input. The pre-training engine extracts selected source code files from various source code repositories. The source code files contain context beyond method bodies, method signatures, and docstrings, such as imports, globals, comments, and scripts. (Collectively, block 402).

Each source code program in the pre-training dataset does need not be written in the same programming language. The pre-training dataset may be composed of numerous source code programs, each of which may be written in a different programming language.

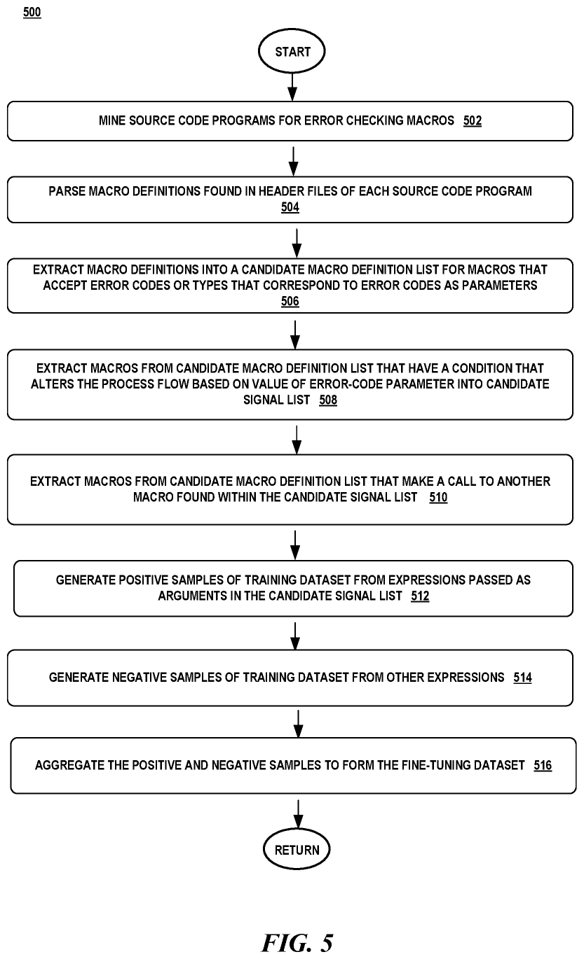

A supervised training dataset of positive and negative samples is generated from the files of a codebase (block 404). Turning to FIG. 5, the training dataset generator mines the source code files of a codebase for error-checking macro definitions used in each source code file of the codebase (block 502). In an aspect, the error-checking macro definitions may be extracted from the header files of each program of a codebase (block 502).

The training dataset generator parses the macro definitions to find those macros having parameters that accept error codes or types that correspond to error codes which are considered error-checking macros (block 504).

For example, consider the following macro definition:

RETURN_IF_ERROR(expr=vulnerable_foo(&var), status=ERROR).

The macro, RETURN_IF_ERROR accepts the parameter, status, which is set to the error code, ERROR. As such, the macro RETURN_IF_ERROR is considered an error-checking macro. These error-checking macros are aggregated into a list of candidate_macro_definitions (block 506).

Each macro definition in the list of candidate_macro_definitions list is then analyzed, in a first pass, for the presence of a condition that alters the flow of the program depending on the value of the error-code parameter. If such a definition exists, the macro is added to a candidate_signal list (block 508).

A second pass is made through the candidate_macro_definitons list to find those macros that make a call to another macro within the candidate_signal list. Those macros are then added to the candidate_signal list (block 510).

For example, consider the following macro definition:

#define RETURN_IF_DATA_ERROR (expr, status) RETURN_IF_ERROR (expr, status=DATA_ERROR).

The macro RETURN_IF_DATA_ERROR uses the macro RETURN_IF_ERROR which is frequently called by other error-checking macros. As such, the macro RETURN_IF_DATA_ERROR is added to the candidate_signal list (block 510).

The macros in the candidate_signal list are then used to generate the positive samples. A positive sample contains the expression used as a parameter in the macro of the candidate_signal list with a label with the value of ‘1’ which indicates that the expression is a possible software vulnerability (block 512).

The negative samples are generated from expressions in the source code program that are not contained in an error-checking macro with a label having the value of ‘0’ which indicates that the expression is not a possible software vulnerability (block 514).

The positive samples and the negative samples with their respective labels are aggregated to form the supervised training set for fine-tuning the pre-trained neural classifier (block 516).

Referring to FIGS. 3 and 4, the supervised training dataset is then used to fine-tune the pre-training neural classifier model on the task of identifying a software vulnerability. Neural transformer models are trained iteratively, making multiple passes over the training dataset before converging to a minimum. An epoch represents the entire training dataset passed forwards and backwards through the neural transformer block once. Since the training dataset is very large, it is partitioned into smaller batches. The training is iterative and the entire dataset is passed through the neural transformer in multiple iterations. Each training iteration includes forward propagation, loss calculation, backpropagation steps followed by updating the weights. The training dataset is partitioned into batches with each batch of sequences running through the training process. (Block 406).

A neural transformer model has multiple blocks and layers within each block so that more detailed relationships within the data are learned as well as how the features interact with each other on a non-linear level. The model architecture, training procedure, data normalization and vocabulary encoding procedures are hyperparameters that are tailored to meet a particular objective. The parameters of a model are the values of the model, such as the attention weights (K, V, Q) and the token embeddings (We, Wp). The hyperparameters influence the way the model is built and how the parameters are learned. (Block 406).

In one aspect, the hyperparameters may include the following: (1) the dimension of the subtoken and position embedding layers; (2) the configuration of the neural transformer model in a particular configuration with a number of encoder blocks and/or decoder blocks; (3) for the training procedure: the cross-entropy loss optimization objective; the sequence length; a mini-batch size; the gradient accumulation steps for each weight update; the stochastic optimization procedure used to train the feed-forward neural network; and the learning rate; (4) the data normalization procedure; and (5) the vocabulary encoding procedure: byte-level byte-pair encoding. (Block 406).

For each sequence of each batch of each epoch, the T-ordered sequences of subtokens are then mapped into numeric vectors and then into respective subtoken embeddings and positional embeddings. An embedding is a learned representation for the text-based subtokens where subtokens that have a common meaning have a common representation. An embedding is a mapping of discrete categorical variables to a vector of continuous numbers. There is an embedding for each subtoken in the vocabulary and a corresponding positional embedding. The subtoken embedding represents the learned representation for the subtoken. The neural transformer model does not read each subtoken sequentially and as such, has no knowledge of the subtoken's position in a sequence without additional position information. The positional embedding is used to embed position information about a subtoken's position in a sequence into a respective neural transformer model.

Initial values are generated for the subtoken embedding and positional embeddings of each sequence which are then used to form a context tensor. Thereafter, the neural transformer model learns the values for each embedding. Upon the completion of the training phase, the embeddings for each subtoken and the positional embeddings are saved into respective matrices for later use. There is a subtoken embedding matrix, We, that contains an embedding vector for each subtoken ti, i=0 . . . . V, and a positional embedding matrix, Wp, that contains an embedding vector Pⱼ, j=0 . . . . T, for each position, where V is the size of the vocabulary and T is the length of the subtoken sequence. (Block 406).

The context tensor is input into a respective neural transformer model and passed through the multiple layers of the neural transformer model. For the encoder neural transformer model, the masked self-attention layer takes the context tensor as input and passes it through the multiple layers of self-attention, layer normalization and feed-forward neural network of each encoder block to finally produce a set of hidden representations. (Block 406).

The feed-forward neural networks in the encoder blocks are trained iteratively, making multiple passes over the training dataset before converging to a minimum. Each training iteration includes forward propagation, loss calculation, backpropagation steps followed by updating the weights by calculating the weight gradients. The loss function estimates the loss or error which is used to compare how good or bad the predicted results are. In one aspect, a categorical cross-entropy loss function is used. Once the loss is calculated, it is propagated backwards to the hidden layer that contributed directly to the output. In backpropagation, the partial derivatives of the loss function with respect to the trainable parameters are determined. The weight gradients are calculated as the difference between the old values and the new values of the weights. The weights are adjusted to make the loss as small as possible using a gradient descent technique. In one aspect, a Stochastic Gradient Descent (SGD) method is the optimization algorithm used to find the values of parameters of the function that minimizes the loss function. A backpropagation algorithm may be used to update the weights. (Block 406).

At the completion of each batch, the parameters of a respective neural transformer model are updated at a preconfigured frequency denoted as Naccum. Naccum is a gradient accumulation frequency. The parameters include the token/subtoken embeddings and the positional embeddings which are stored in a respective embedding matrix. (Block 406).

Next, the neural transformer model is validated. Before the neural transformer model is trained, a set of hyperparameters is selected randomly and then tuned to achieve a desired performance. The neural transformer model is tested using a validation dataset to determine the appropriate hyperparameters settings to achieve a desired goal. When the desired goal is not achieved, one or more hyperparameters are adjusted and the training is repeated until the target goal is achieved. Perplexity on the validation set is calculated to validate the performance of the model with respect to the learning the masked out original text. (Block 406).

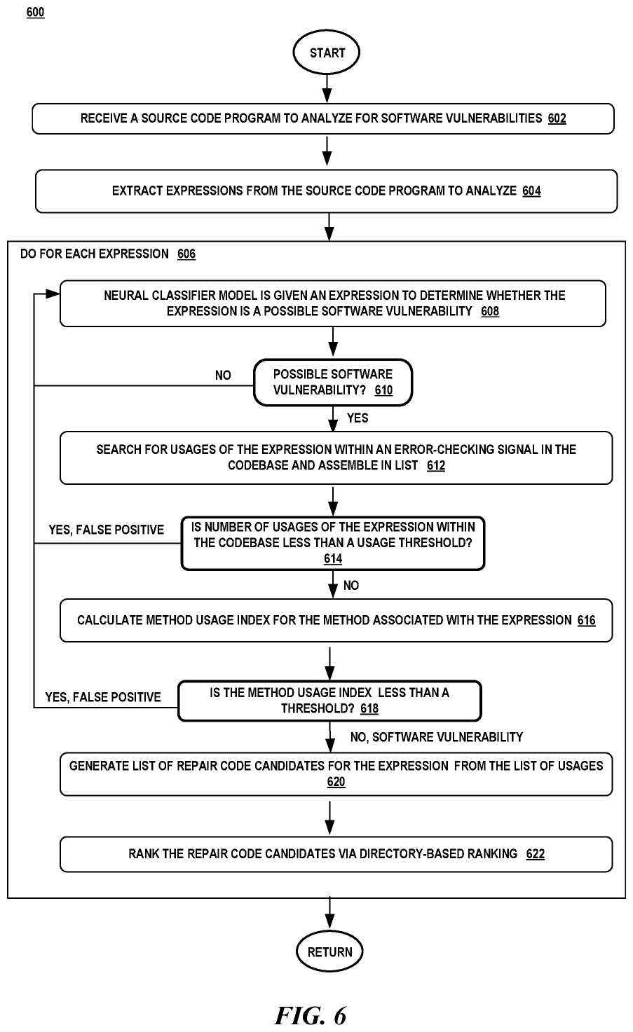

FIG. 6 illustrates an exemplary method of the inference phase of the source code repair system 600. The source code repair system receives a source code program to analyze from the codebase (block 602). The pre-processing component extracts expressions from the source code program (block 604) and analyzes each one as a possible software vulnerability (block 606). The neural classifier model, given an expression, identifies the probability that the expression is a possible software vulnerability (block 608). If the neural classifier model determines that it is not likely to be a possible software vulnerability (block 610-No), the next expression is analyzed, if any.

When the neural classifier model infers that the expression is likely to be a possible software vulnerability (block 610—Yes), then a search is performed on the files of the codebase for all occurrences or usages of the expression within an error-checking signal (block 612). The usages of the expression within an error-checking signal are aggregated into a list of usages of the expression (block 612). If the number of usages of the expression is less than a threshold (block 614—Yes), then the expression is considered a false positive and the next expression is analyzed, if any.

Otherwise (block 614—No), a method usage index is calculated for the expression (block 616). The method usage index pertains to the method used in the expression. The method usage index is the ratio of the number of times the method is used in an expression of an error-checking macro over the number of times the method is used in the codebase. In an aspect, the values of the method usage index are within the range (0,1). The threshold may be greater or equal to 0.6 which ensures that the expression is not a false positive.

If the method usage index exceeds the threshold, the expression is considered a likely software vulnerability (block 618—No). The list of usages of the expression within an error-checking macro is then used as repair code candidates or suggestions to repair the expression when found used in the codebase outside of an error-checking macro (block 620).

The list of repair code candidates is then ranked via a directory-based ranking (block 622). The directory-based ranking orders the repair code candidates within the list of repair code candidates based on the closest matching directory and file name of each repair code candidate to the directory and file name of the source code file containing the software vulnerability. The repair code candidates closest to the directory and file name of the source code file are the most relevant to the expression than repair code candidates from a different directory to the source code file containing the expression.

### Technical Effect/Improvement

Aspects of the subject matter disclosed herein pertain to the technical problem of identifying software vulnerabilities contained in source code. The technical features associated with addressing this problem is the use of error-checking signals to identify code patterns indicative of a context of a software vulnerability, the mining of those signals from a vast amount of source code, the training of a classifier model to learn to accurately identify a software vulnerable code pattern, the use of the classifier model to make the predictions, the identification of false positives using semantic matching and the method usage index, and ranking the repair code candidates using directory-based ranking. The technical effect achieved is the early detection of vulnerable code before the code is released.

The training of a neural classifier model to perform the classification requires a large amount of data to achieve the accuracy needed to make predictions, especially on unseen data. The training thereby consumes a considerable amount of computing resources and time. The inference phase of the source repair system in a target system has to perform within tight timing requirements in order to be viable in the target system. For at least these reasons, the training and inference performed by the source code repair system needs to be performed on a computing device. The operations performed are inherently digital. A human mind cannot interface directly with a CPU, or network interface card, or other processor, or with RAM or digital storage, to read and write the necessary data and perform the necessary operations and processing steps taught herein.

Embodiments are also presumed to be capable of operating “at scale”, that is capable of handling larger volumes, in production environments or in testing labs for production environments as opposed to being mere thought experiments.

The technique described herein is a technical improvement over prior solutions that were limited to static analysis tools. Even though traditional tools can analyze code statically, without executing them, they require the codebase to be compiled and built in order to bring the source code artifacts to a representation upon which these analyzers can work. There is a known significant cost to building codebases, which increases with the codebase size. Large codebases can take hours or days to build which causes challenge and friction to enable a static analyzer. The runtime of the static analysis tools is affected by the size of the codebase.

In contrast, the disclosed technique works on raw code and textual code as is without needing to be compiled or build. It scales very easily with the size of the codebase. The system can work in an IDE to give immediate feedback to the developer while writing code, run on checked-in code in a version-controlled source code repository, and can be enabled seamlessly, as per technical constraints, requirements or convenience.

The traditional static analysis tools rely on data containing labeled instances of buggy code and safe code. This data is typically generated by running the static analysis tool and then labeling whether the warning generated by them were actual bugs or false positives. The creation of this data is time-consuming and expensive and often becomes a bottleneck to training classifier models to detect buggy expressions. The disclosed system of detecting software vulnerabilities eliminates the need to look for this kind of data by leveraging the error checking macros found in the programs.

In addition, the disclosed system generates “actionable” warnings by showing ways of addressing the software vulnerability by referencing correct usages within the codebase. Traditional static analysis tools suffer from not only a high false positive noise rate but they are not inherently “actionable” and usually do not report correct usages or suggest fixes with the reported warnings.

The disclosed system identifies the correct usage of a code expression specific to a given codebase. Traditional static analyzers use generic rules that may not be applicable to a particular codebase thereby producing a large number of false positives.

### Exemplary Operating Environment

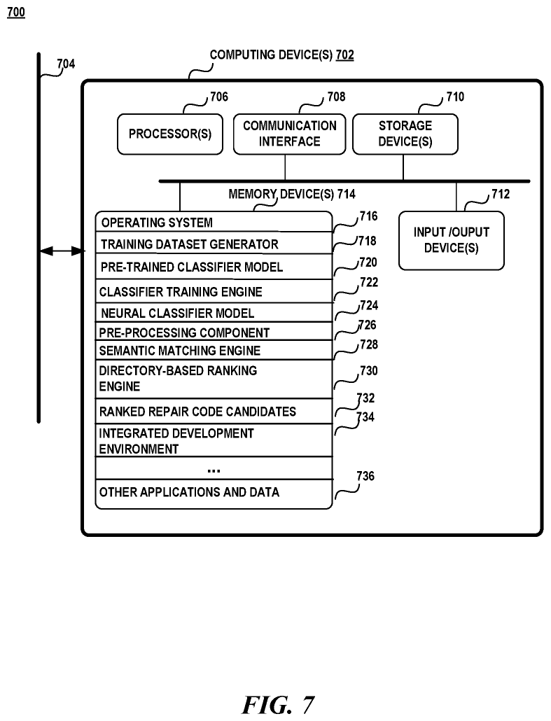

Attention now turns to a discussion of an exemplary operating environment 700. FIG. 7 illustrates an exemplary operating environment 700 having one or more computing devices 702 communicatively coupled to a network 704.

The computing devices 702 may be any type of electronic device, such as, without limitation, a mobile device, a personal digital assistant, a mobile computing device, a smart phone, a cellular telephone, a handheld computer, a server, a server array or server farm, a web server, a network server, a blade server, an Internet server, a work station, a mini-computer, a mainframe computer, a supercomputer, a network appliance, a web appliance, a distributed computing system, multiprocessor systems, or combination thereof. The operating environment 700 may be configured in a network environment, a distributed environment, a multi-processor environment, or a stand-alone computing device having access to remote or local storage devices.

A computing device 702 may include one or more processors 706, one or more communication interfaces 708, one or more storage devices 710, one or more input/output devices 712, and one or more memory devices 714. A processor 706 may be any commercially available or customized processor and may include dual microprocessors and multi-processor architectures. A communication interface 708 facilitates wired or wireless communications between the computing device 702 and other devices. A storage device 710 may be computer-readable medium that does not contain propagating signals, such as modulated data signals transmitted through a carrier wave. Examples of a storage device 710 include without limitation RAM, ROM, EEPROM, flash memory or other memory technology, CD-ROM, digital versatile disks (DVD), or other optical storage, magnetic cassettes, magnetic tape, magnetic disk storage, all of which do not contain propagating signals, such as modulated data signals transmitted through a carrier wave. There may be multiple storage devices 710, in a computing device 702. The input/output devices 712 may include a keyboard, mouse, pen, voice input device, touch input device, display, speakers, printers, etc., and any combination thereof.

A memory device 714 may be any non-transitory computer-readable storage media that may store executable procedures, applications, and data. The computer-readable storage media does not pertain to propagated signals, such as modulated data signals transmitted through a carrier wave. It may be any type of non-transitory memory device (e.g., random access memory, read-only memory, etc.), magnetic storage, volatile storage, non-volatile storage, optical storage, DVD, CD, floppy disk drive, etc. that does not pertain to propagated signals, such as modulated data signals transmitted through a carrier wave. A memory device 714 may also include one or more external storage devices or remotely located storage devices that do not pertain to propagated signals, such as modulated data signals transmitted through a carrier wave.

The memory device 714 may contain instructions, components, and data. A component is a software program that performs a specific function and is otherwise known as a module, program, component, and/or application. The memory device 714 may include an operating system 716, a training dataset generator 718, a pre-trained classifier model 720, a classifier training engine 722, a neural classifier model 724, a pre-processing component 726, a semantic matching engine 728, a directory-based ranking engine 730, ranked repair code candidates 734, an Integrated Development Environment 736, and other applications and data 738.

The computing device 702 may be communicatively coupled via a network 704. The network 704 may be configured as an ad hoc network, an intranet, an extranet, a virtual private network (VPN), a local area network (LAN), a wireless LAN (WLAN), a wide area network (WAN), a wireless WAN (WWAN), a metropolitan network (MAN), the Internet, a portion of the Public Switched Telephone Network (PSTN), plain old telephone service (POTS) network, a wireless network, a WiFi® network, or any other type of network or combination of networks.

The network 704 may employ a variety of wired and/or wireless communication protocols and/or technologies. Various generations of different communication protocols and/or technologies that may be employed by a network may include, without limitation, Global System for Mobile Communication (GSM), General Packet Radio Services (GPRS), Enhanced Data GSM Environment (EDGE), Code Division Multiple Access (CDMA), Wideband Code Division Multiple Access (W-CDMA), Code Division Multiple Access 2000, (CDMA-2000), High Speed Downlink Packet Access (HSDPA), Long Term Evolution (LTE), Universal Mobile Telecommunications System (UMTS), Evolution-Data Optimized (Ev-DO), Worldwide Interoperability for Microwave Access (WiMax), Time Division Multiple Access (TDMA), Orthogonal Frequency Division Multiplexing (OFDM), Ultra Wide Band (UWB), Wireless Application Protocol (WAP), User Datagram Protocol (UDP), Transmission Control Protocol/Internet Protocol (TCP/IP), any portion of the Open Systems Interconnection (OSI) model protocols, Session Initiated Protocol/Real-Time Transport Protocol (SIP/RTP), Short Message Service (SMS), Multimedia Messaging Service (MMS), or any other communication protocols and/or technologies.

### CONCLUSION

A system is disclosed comprising: one or more processors; and a memory that stores one or more programs that are configured to be executed by the one or more processors. The one or more programs including instructions that perform acts to: receive a source code file having at least one expression, wherein the source code file is associated with a codebase, wherein the codebase includes a plurality of files; infer, through a neural classifier given the at least one expression, that the at least one expression has a possible software vulnerability, wherein the neural classifier infers the possible software vulnerability from recognizing patterns learned from arguments used in expressions of error-checking macros in the plurality of files of the codebase; search the plurality of files of the codebase for occurrences of the at least one expression; assemble a plurality of repair code candidates from occurrences of the at least one expression found in the codebase within an error-checking macro; and output the plurality of repair code candidates as suggestions to fix the potential software vulnerability.

In an aspect, the one or more programs include instructions that perform acts to: determine that the at least one expression is a potential software vulnerability when a number of occurrences of the at least one expression in the codebase exceeds a threshold. In an aspect, the one or more programs include instructions that perform acts to: determine that the at least one expression is a software vulnerability when the at least one expression invokes a method that is used frequently in an error-checking macro in the plurality of files of the codebase.

In an aspect, the one or more programs include instructions that perform acts to: compute a method usage index for each method of each expression, wherein the method usage index is the ratio of a number of times a method is used in an error-checking signal over a number of times the method is used in the plurality of files of the codebase. In an aspect, the one or more programs include instructions that perform acts to: rank the plurality of repair code candidates based on each repair code candidate closely matching a directory and file name of the source code program having the software vulnerability.

In an aspect, each of the plurality of repair code candidates includes an error-checking macro. In an aspect, the neural classifier includes a neural encoder transformer with attention.

A computer-implemented method is disclosed, comprising: extracting a first plurality of expressions used in error-checking macros from a plurality of source code files of a codebase; extracting a second plurality of expressions used outside of the error-checking macros from the plurality of source code files of the codebase; forming a fine-tuning dataset including the first plurality of expressions and the second plurality of expressions, wherein each expression of the first plurality of expressions includes a label indicating a software vulnerability, wherein each expression of the second plurality of expressions includes a label indicating no software vulnerability; obtaining a pre-trained neural classifier model; fine-tuning the pre-trained neural classifier model with the fine-tuning dataset to learn to predict whether an expression of a source code program contains a software vulnerability; and deploying the fine-tuned neural classifier model in a source code repair system to identify a software vulnerability in a source code program of the codebase.

In an aspect, the error-checking macros accept error codes or types that correspond to error codes and alter flow of a source code program based on a value of an error code. In an aspect, the error-checking macro invokes a second error-checking macro that accepts an error code or type that corresponds to an error code and alters flow of a source code program based on a value of an error code.

In an aspect, the fine-tuned neural classifier model is deployed in a version-controlled software hosting service. In an aspect, the fine-tuned neural classifier model is deployed in an integrated development environment. In an aspect, the pre-trained neural classifier model includes a neural encoder transformer with attention. In an aspect, the fine-tuned neural classifier model is a neural encoder transformer model with attention.

One or more hardware storage devices are disclosed having stored thereon computer executable instructions that are structured to be executable by one or more processors of a computing device to thereby cause the computing device to perform actions that: extract at least one expression from a source code file associated with a codebase, wherein the codebase includes a plurality of files; determine, through a neural classifier given the at least one expression, that the at least one expression has a possible software vulnerability, wherein the neural classifier infers the possible software vulnerability from recognizing patterns learned from arguments used in error-checking macros in the plurality of files of the codebase; search the plurality of files of the codebase for occurrences of the at least one expression; assemble a plurality of repair code candidates from occurrences of the at least one expression found in the codebase within an error-checking macro; and output the plurality of repair code candidates as suggestions to fix the potential software vulnerability.

In an aspect, the one or more hardware storage devices having stored thereon computer executable instructions that are structured to be executable by one or more processors of a computing device to thereby cause the computing device to perform actions that: rank the plurality of repair code candidates based on each repair code candidate closely matching a directory and file name of the source code program having the software vulnerability.

In an aspect, the one or more hardware storage devices having stored thereon computer executable instructions that are structured to be executable by one or more processors of a computing device to thereby cause the computing device to perform actions that: output each of the plurality of repair code candidates to a source code editor.

In an aspect, the one or more hardware storage devices having stored thereon computer executable instructions that are structured to be executable by one or more processors of a computing device to thereby cause the computing device to perform actions that: eliminate a first expression as having a possible software vulnerability based on the first expression occurring less than a threshold number of occurrences in the codebase.

In an aspect, the one or more hardware storage devices having stored thereon computer executable instructions that are structured to be executable by one or more processors of a computing device to thereby cause the computing device to perform actions that: eliminate a first expression as having a possible software vulnerability based on a method used in the expression being invoked less than a threshold number of invocations in the codebase.

In an aspect, the neural classifier is a neural encoder transformer with attention.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It may be appreciated that the representative methods do not necessarily have to be executed in the order presented, or in any particular order, unless otherwise indicated. Moreover, various activities described with respect to the methods can be executed in serial or parallel fashion, or any combination of serial and parallel operations. In one or more aspects, the method illustrates operations for the systems and devices disclosed herein.

The techniques described herein are not limited to using the error-checking macros as signals of a context of a software vulnerability. Other signals that can be used include other error checking functions in programming languages that do not support macros, such as log handlers, exception handling blocks which are code patterns that occur within the “try” blocks, and templated conditions. Templated conditions are certain conditions that are known to produce a bug and which are explicitly wrapped around an if-condition, such as examples of pointers in a codebase that can return null pointers.

What is claimed:

1. A system comprising:
one or more processors; and
a memory that stores one or more programs that are configured to be executed by the one or more processors, the one or more programs including instructions that perform acts to:
receive a source code file having at least one expression, wherein the source code file is associated with a codebase, wherein the codebase includes a plurality of files;
infer, through a neural classifier given the at least one expression, that the at least one expression has a possible software vulnerability, wherein the neural classifier infers the possible software vulnerability from recognizing patterns learned from arguments used in expressions of error-checking macros in the plurality of files of the codebase;
search the plurality of files of the codebase for occurrences of the at least one expression;
assemble a plurality of repair code candidates from occurrences of the at least one expression found in the codebase within an error-checking macro; and
output the plurality of repair code candidates as suggestions to fix the potential software vulnerability.

2. The system of claim 1, wherein the one or more programs include instructions that perform acts to:
determine that the at least one expression is a potential software vulnerability when a number of occurrences of the at least one expression in the codebase exceeds a threshold.

3. The system of claim 2, wherein the one or more programs include instructions that perform acts to:
determine that the at least one expression is a software vulnerability when the at least one expression invokes a method that is used frequently in an error-checking macro in the plurality of files of the codebase.

4. The system of claim 1, wherein the one or more programs include instructions that perform acts to:
compute a method usage index for each method of each expression, wherein the method usage index is the ratio of a number of times a method is used in an error-checking signal over a number of times the method is used in the plurality of files of the codebase.

5. The system of claim 1, wherein the one or more programs include instructions that perform acts to: rank the plurality of repair code candidates based on each repair code candidate closely matching a directory and file name of the source code program having the software vulnerability.

6. The system of claim 1, wherein each of the plurality of repair code candidates includes an error-checking macro.

7. The system of claim 1, wherein the neural classifier includes a neural encoder transformer with attention.

8. A computer-implemented method, comprising:
extracting a first plurality of expressions used in error-checking macros from a plurality of source code files of a codebase;
extracting a second plurality of expressions used outside of the error-checking macros from the plurality of source code files of the codebase;
forming a fine-tuning dataset including the first plurality of expressions and the second plurality of expressions, wherein each expression of the first plurality of expressions includes a label indicating a software vulnerability, wherein each expression of the second plurality of expressions includes a label indicating no software vulnerability;
obtaining a pre-trained neural classifier model;
fine-tuning the pre-trained neural classifier model with the fine-tuning dataset to learn to predict whether an expression of a source code program contains a software vulnerability; and
deploying the fine-tuned neural classifier model in a source code repair system to identify a software vulnerability in a source code program of the codebase.

9. The computer-implemented method of claim 8, wherein the error-checking macros accept error codes or types that correspond to error codes and alter flow of a source code program based on a value of an error code.

10. The computer-implemented method of claim 8, wherein an error-checking macro invokes a second error-checking macro that accepts an error code or type that corresponds to an error code and alters flow of a source code program based on a value of an error code.

11. The computer-implemented method of claim 8, wherein the fine-tuned neural classifier model is deployed in a version-controlled software hosting service.

12. The computer-implemented method of claim 8, wherein the fine-tuned neural classifier model is deployed in an integrated development environment.

13. The computer-implemented method of claim 8, wherein the pre-trained neural classifier model includes a neural encoder transformer with attention.

14. The computer-implemented method of claim 8, wherein the fine-tuned neural classifier model is a neural encoder transformer model with attention.

15. One or more hardware storage devices having stored thereon computer executable instructions that are structured to be executable by one or more processors of a computing device to thereby cause the computing device to perform actions that:
extract at least one expression from a source code file associated with a codebase, wherein the codebase includes a plurality of files;
determine, through a neural classifier given the at least one expression, that the at least one expression has a possible software vulnerability, wherein the neural classifier infers the possible software vulnerability from recognizing patterns learned from arguments used in error-checking macros in the plurality of files of the codebase;
search the plurality of files of the codebase for occurrences of the at least one expression;
assemble a plurality of repair code candidates from occurrences of the at least one expression found in the codebase within an error-checking macro; and
output the plurality of repair code candidates as suggestions to fix the potential software vulnerability.

16. The one or more hardware storage devices of claim 15 having stored thereon computer executable instructions that are structured to be executable by one or more processors of a computing device to thereby cause the computing device to perform actions that:
rank the plurality of repair code candidates based on each repair code candidate closely matching a directory and file name of the source code program having the software vulnerability.

17. The one or more hardware storage devices of claim 15 having stored thereon computer executable instructions that are structured to be executable by one or more processors of a computing device to thereby cause the computing device to perform actions that:
output each of the plurality of repair code candidates to a source code editor.

18. The one or more hardware storage devices of claim 15 having stored thereon computer executable instructions that are structured to be executable by one or more processors of a computing device to thereby cause the computing device to perform actions that:
eliminate a first expression as having a possible software vulnerability based on the first expression occurring less than a threshold number of occurrences in the codebase.

19. The one or more hardware storage devices of claim 15 having stored thereon computer executable instructions that are structured to be executable by one or more processors of a computing device to thereby cause the computing device to perform actions that:
eliminate a first expression as having a possible software vulnerability based on a method used in the expression being invoked less than a threshold number of invocations in the codebase.

20. The one or more hardware storage devices of claim 15, wherein the neural classifier is a neural encoder transformer with attention.
